(19) United States
(12) Patent Application Publication
(10) Pub. No.: US 2026/0084425 A1
(43) Pub. Date: Mar. 26, 2026

(54) LIQUID EJECTION HEAD

(71) Applicant: BROTHER KOGYO KABUSHIKI KAISHA, Nagoya (JP)

(72) Inventors: Toru YAMASHITA, Nagoya (JP); Takashi AIBA, Nagoya (JP)

(73) Assignee: BROTHER KOGYO KABUSHIKI KAISHA, Nagoya (JP)

(21) Appl. No.: 19/295,921

(22) Filed: Aug. 11, 2025

(30) Foreign Application Priority Data
Sep. 20, 2024 (JP) 2024-163340

(51) Int. Cl. B41J 2/14; B41J 2/045

(52) U.S. Cl. CPC B41J 2/14233; B41J 2/04548; B41J 2/0457; B41J 2/04573; B41J 2/04581; B41J 2/0459; B41J 2002/14491

(57) ABSTRACT

A liquid ejection head includes a flow path member including a plurality of pressure chambers, an actuator member including a plurality of individual electrodes and a plurality of first contacts, the plurality of first contacts being arranged on an upper surface of the actuator member and connected to the plurality of individual electrodes, respectively, a wiring member including a plurality of wirings, each of the plurality of wirings having a second contact at one end, the second contact being connected to the plurality of first contacts, and a driving member including a plurality of output terminals configured to output a drive signal, each of the plurality of output terminals being connected to another end of the plurality of wirings. At least two of a plurality of the second contacts are connected to one of the plurality of first contacts.

### REFERENCE TO RELATED APPLICATIONS

This application claims priority under 35 U.S.C. § 119 from Japanese Patent Application No. 2024-163340 filed on Sep. 20, 2024. The entire subject matter of the application is incorporated herein by reference.

### BACKGROUND ART

The present disclosure relates to a liquid ejection head configured to eject liquid.

There is known a liquid ejection head (e.g., an inkjet head) including a flow path unit (flow path member) having a plurality of pressure chambers, actuator members (e.g., piezoelectric actuators) arranged on an upper surface of the flow path unit, and a flexible wiring material (wiring member) including a plurality of wiring patterns. The actuator members are arranged in a particular pattern. Each actuator member includes a plurality of individual electrodes overlapping the corresponding pressure chambers in the vertical direction and a plurality of individual surface electrodes disposed on the upper surface and connected to the respective individual electrodes. A driving member (e.g., a driver IC) connected to the plurality of wiring patterns is mounted on the flexible wiring material. The plurality of wiring patterns includes a plurality of individual connection electrodes connected to the respective individual surface electrodes. In the liquid ejection head, a particular voltage is applied to the plurality of individual electrodes based on a drive signal output from the driver IC, thereby applying pressure to the ink in the plurality of pressure chambers.

### SUMMARY

In the conventional technology as mentioned above, typically, the output terminal of the driver IC and the individual connection electrodes are electrically connected via a single output wiring pattern. As a result, the transmission path for the drive signals output from the driver IC to the multiple individual electrodes is limited to one path per individual electrode. When the driver IC drives the piezoelectric actuator at high speed, transmission loss in the single transmission path affects the individual electrodes, leading to a degradation in the quality of the drive signals supplied to them. Furthermore, since the output terminal of the driver IC and the individual connection electrodes are electrically connected via a single output wiring pattern, disconnection or changes in output characteristics may occur due to pressure applied during head manufacturing, further deteriorating the quality of the drive signals supplied to the individual electrodes.

According to aspects of the present disclosure, a liquid ejection head includes a flow path member including a plurality of pressure chambers, an actuator member arranged on an upper surface of the flow path member, the actuator member including a plurality of individual electrodes and a plurality of first contacts, the plurality of individual electrodes overlapping the plurality of pressure chambers in an up-down direction, respectively, the plurality of first contacts being arranged on an upper surface of the actuator member and connected to the plurality of individual electrodes, respectively, a wiring member arranged on the upper surface of the actuator member, the wiring member including a plurality of wirings, each of the plurality of wirings having a second contact at one end, the second contact being connected to the plurality of first contacts, and a driving member including a plurality of output terminals configured to output a drive signal, each of the plurality of output terminals being connected to another end of the plurality of wirings. At least two of a plurality of the second contacts are connected to one of the plurality of first contacts.

### BRIEF DESCRIPTION OF THE DRAWINGS

FIG. 1 is a plan view of a printer including a head.

FIG. 2 is a perspective view of the head.

FIG. 3 is a sectional view of the head taken along line III-III in FIG. 2.

FIG. 4 is a development view of a COF (Chip-on-Film) included in the head, as seen from the lower surface.

FIG. 5 is a plan view of a flow path member and an actuator member included in the head.

FIG. 6 is a sectional view of the head taken along line VI-VI in FIG. 5.

FIG. 7 is an enlarged view of region VII shown in FIG. 4.

FIGS. 8A and 8B are graphs showing a drive signal output by a driver IC included in the head.

FIG. 9 is a block diagram illustrating an electrical configuration of the printer shown in FIG. 1.

FIGS. 10A, 10B and 10C show other examples of graphs showing drive signals output by the driver IC.

FIGS. 11A, 11B and 11C show still other examples of graphs showing drive signals output by the driver IC.

FIG. 12 is another enlarged view of region VII of the COF included in the head.

### DESCRIPTION

### First Embodiment

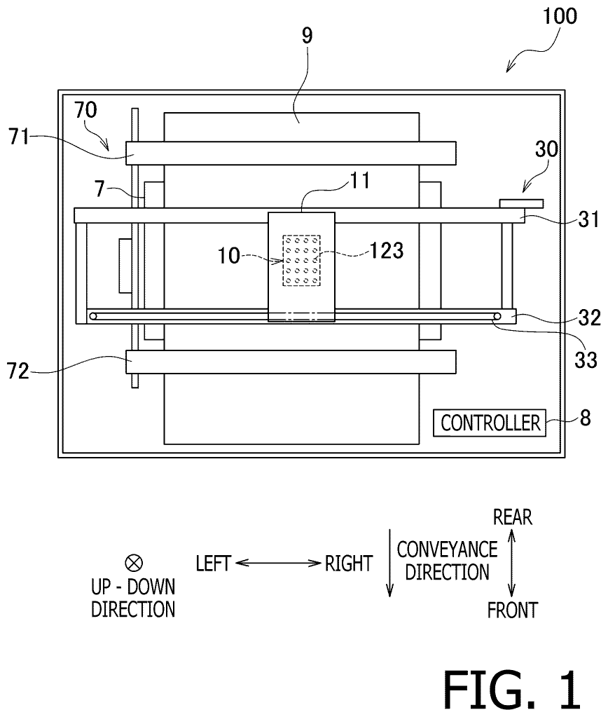

FIG. 1 shows a printer 100 including a head 10, which is a liquid ejection head according to aspects of the present disclosure. In the following description, an up-down direction is defined based on an installed state of the printer 100. A front-rear direction is defined such that a downstream side in a conveyance direction of a printing sheet 9 corresponds to a front side. A left-right direction is defined such that left and right sides of the printer 100 correspond to a left-hand side and a right-hand side, respectively, when viewed from the front of the printer 100. The up-down direction, the front-rear direction, and the left-right direction are mutually orthogonal. The front-rear direction corresponds to the ‘first direction’ according to aspects of the present disclosure, and the left-right direction corresponds to the ‘second direction’ according to aspects of the present disclosure.

The printer 100 includes the head 10, a carriage 11 that holds the head 10, a scanning mechanism 30 configured to move the carriage 11 and the head 10 in a scanning direction parallel to the left-right direction, a platen 7 that supports a printing sheet 9 from below, a conveyance mechanism 70 configured to convey the printing sheet 9 forward, and a controller 8.

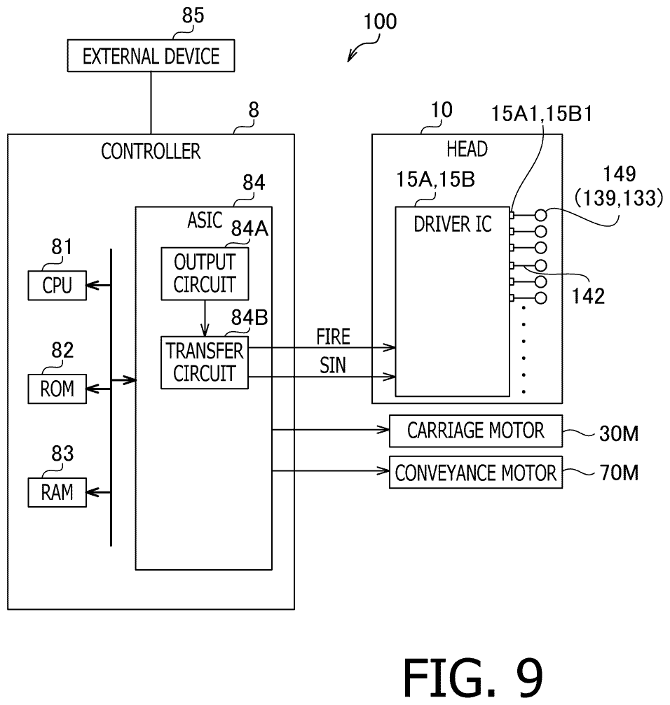

The scanning mechanism 30 includes a pair of guides 31 and 32 that support the carriage 11 and a belt 33 connected to the carriage 11. The guides 31 and 32 and the belt 33 extend in the left-right direction. When a carriage motor 30M (see FIG. 9) is driven under the control of the controller 8, the belt 33 moves, causing the carriage 11 and the head 10 to move in the scanning direction along the guides 31 and 32.

The platen 7 is arranged below the carriage 11 and the head 10. The printing sheet 9 is supported on an upper surface of the platen 7.

The conveyance mechanism 70 includes a roller 71 arranged rearward of the head 10 and a roller 72 arranged in front of the head 10. The head 10, the carriage 11, and the platen 7 are arranged between the roller 71 and the roller 72 in the front-rear direction.

The rollers 71 and 72 each include a pair of rotating members. Each pair of rotating members includes an upper rotating member arranged above a conveyance path of the printing sheet 9 and a lower rotating member arranged below the conveyance path of the printing sheet 9. The upper rotating member and the lower rotating member of each of the rollers 71 and 72 are arranged such that their peripheral surfaces are in contact with each other when no printing sheet 9 is present therebetween.

When a conveyance motor 70M (see FIG. 9) is driven under the control of the controller 8, each rotating member of the rollers 71 and 72 rotates. As the upper and lower rotating members of the rollers 71 and 72 rotate while holding the printing sheet 9 therebetween, the printing sheet 9 is conveyed forward.

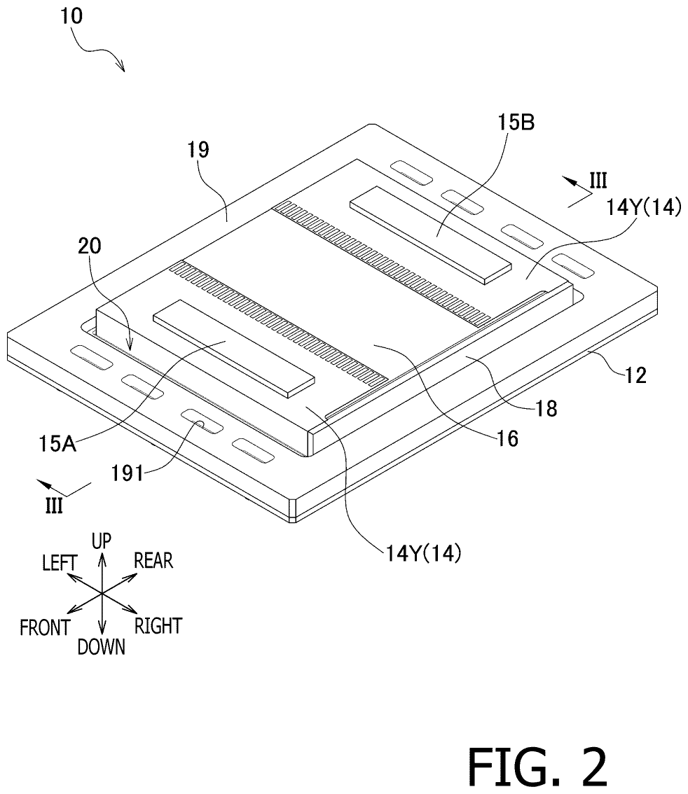

The head 10, as shown in FIGS. 2 to 6, includes a flow path member 12, an actuator member 13, a COF (Chip-On-Film) 14, driver ICs 15A and 15B, and a frame 19. The COF 14 is an example of a “wiring member” according to the present disclosure. The driver ICs 15A and 15B are mounted on the COF 14 and electrically connected to the controller 8 (see FIG. 9). The driver ICs 15A and 15B are examples of a “driving member” according to the present disclosure. The controller 8 is an example of a processor according to the present disclosure.

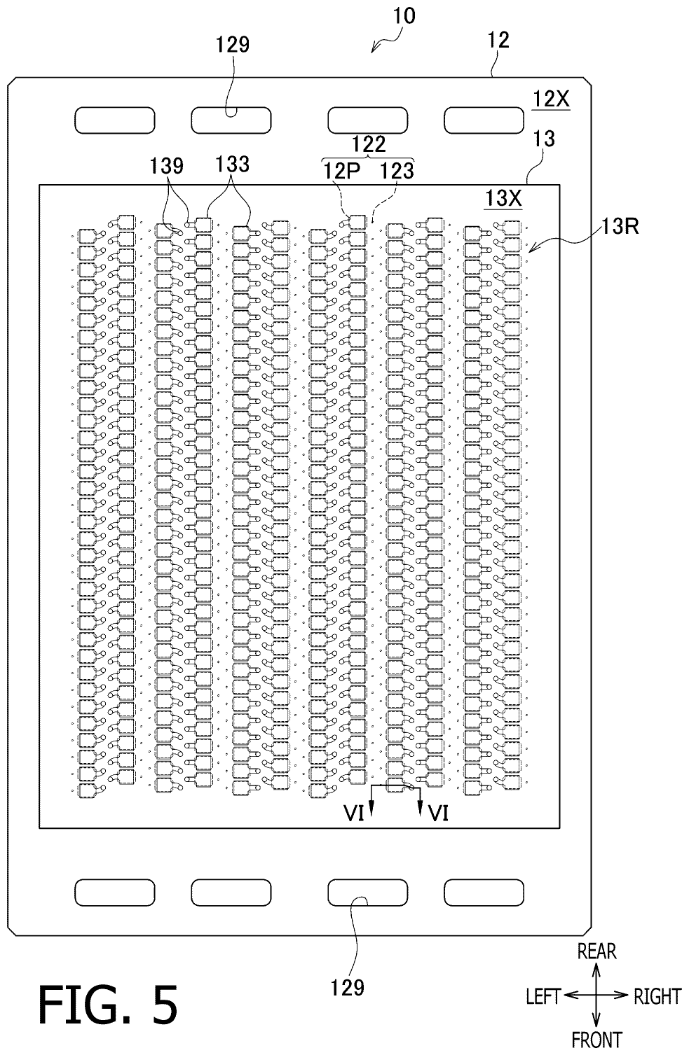

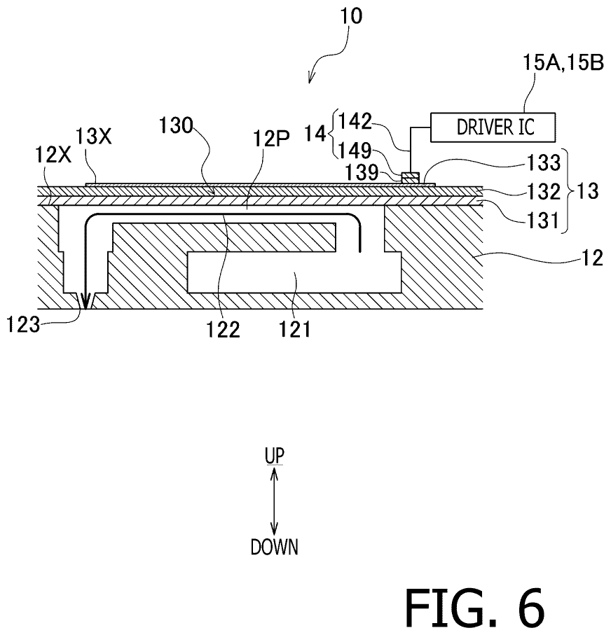

The flow path member 12, the actuator member 13, and the frame 19 have a rectangular shape elongated in the front-rear direction in a plane orthogonal to the up-down direction, as shown in FIG. 2. As shown in FIGS. 5 and 6, a plurality of nozzles 123 are formed as openings on the lower surface of the flow path member 12. Inside the flow path member 12, a common flow path 121 and individual flow paths 122 corresponding to the respective nozzles 123 are formed. Each individual flow path 122 extends from an outlet of the common flow path 121 through a pressure chamber 12P to the corresponding nozzle 123.

As shown in FIG. 5, a plurality of pressure chambers 12P are formed on the upper surface 12X of the flow path member 12. Specifically, the plurality of pressure chambers 12P are formed as openings in the region where the actuator member is arranged. On the upper surface 12X of the flow path member 12, four openings 129 are arranged on both the front and rear sides of the region where the actuator member 13 is arranged. These openings 129 communicate with the common flow path 121.

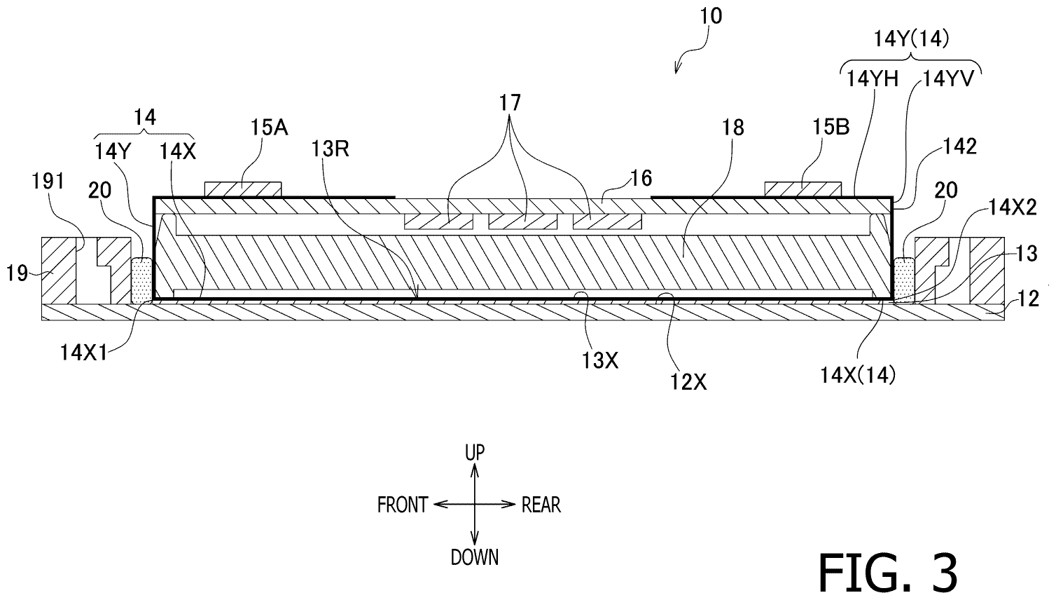

As shown in FIGS. 2 and 3, the frame 19 is a rectangular frame arranged along the periphery of the flow path member 12 and arranged around the actuator member 13 on the upper surface 12X of the flow path member 12. Four openings 191 are formed on each of the front and rear end portions of the frame 19. Each opening 191 communicates with the openings 129 of the flow path member 12 and is also connected to an ink tank via a tube. For example, ink in the ink tank flows into the common flow path 121 through the tube and the four front openings 191 and returns to the ink tank through the four rear openings 191 and the tube.

As shown in FIGS. 3, 5, and 6, the actuator member 13 is arranged on the upper surface 12X of the flow path member 12 so as to cover the plurality of pressure chambers 12P. As shown in FIG. 6, the actuator member 13 includes a metal diaphragm 131 arranged on the upper surface 12X of the flow path member 12, a piezoelectric layer 132 arranged on the upper surface of the diaphragm 131, and a plurality of individual electrodes 133 arranged on the upper surface of the piezoelectric layer 132 so as to face the respective pressure chambers 12P. The diaphragm 131 is spaced apart from the individual electrodes 133 in the vertical direction.

The diaphragm 131 and the plurality of individual electrodes 133 are electrically connected to the driver ICs 15A and 15B via the COF 14. The driver ICs 15A and 15B are electrically connected to the controller 8.

On an upper side of the actuator member 13 (e.g., on the upper surface of the piezoelectric layer 132), a contact (not shown) electrically connected to the diaphragm 131 is provided, and contacts 139 are arranged on the upper surfaces 13X of the individual electrodes 133. The COF 14 includes contacts 149 electrically connected to the respective contacts 139 arranged on the upper surface 13X, and wirings 142 that electrically connect the contacts 149 to the driver ICs 15A and 15B. The COF 14 also includes a contact electrically connected to the contact that is electrically connected to the diaphragm 131 of the actuator member 13, and a wiring (both not shown) that electrically connects this contact to the driver ICs 15A and 15B. The contacts 139 are examples of “first contacts” according to the present disclosure, and the contacts 149 are examples of “second contacts” according to the present disclosure.

In a physical configuration, the two wirings 142 may be connected to either two separate physical contacts 149 or a single shared physical contact 149, provided that, in either case, the contact(s) 149 are connected to the same physical contact 139. In the following description, for the sake of clarity, the singular or plural form may be used interchangeably to refer to the contact(s) 149 connected to the same contact 139.

The driver ICs 15A and 15B, under the control of the controller 8, maintain the potential of the diaphragm 131 at a ground potential while varying the potential of the individual electrodes 133. Specifically, the driver ICs 15A and 15B generate drive signals based on control signals (a waveform signal FIRE and a selection signal SIN) from the controller 8 and supply the drive signals to the individual electrodes 133 via the wirings 142. As a result, the potential of the individual electrodes 133 varies between a particular drive potential and the ground potential.

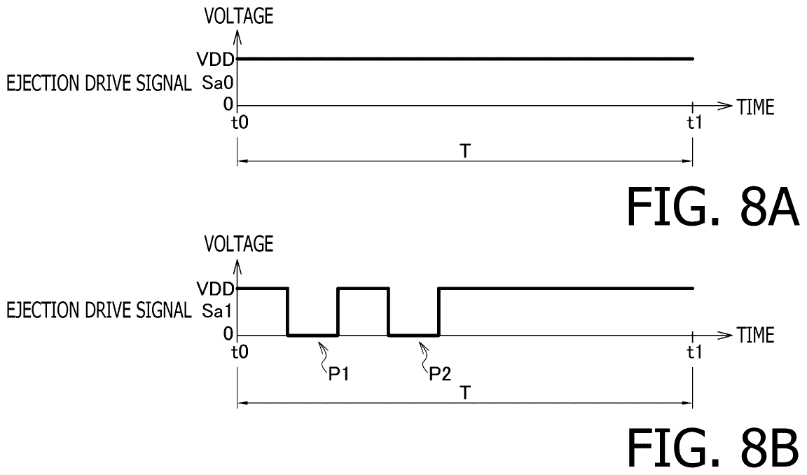

The drive signal includes ejection drive signals Sa0 and Sa1, as shown in FIGS. 8A and 8B. The ejection drive signals Sa0 and Sa1 correspond to the amount of ink ejected from the nozzle 123 per unit time T (one ejection cycle from time t0 to time t1), respectively. The unit time T is the time required for the printing sheet 9 to relatively move by a unit distance corresponding to the resolution of the image to be formed on the printing sheet 9 with respect to the head 10 and corresponds to one dot (one pixel).

The ejection drive signal Sa0, which corresponds to an ejection amount of zero, does not include any pulses within the unit time T and does not eject ink from the nozzle 123. The ejection drive signal Sa1, which corresponds to a desired ejection amount, includes two pulses P1 and P2 within the unit time T and ejects the desired amount of ink from the nozzle 123. The two pulses P1 and P2 are rectangular pulses with the same pulse width. However, the shape of the pulses is not limited to a rectangular shape.

In this embodiment, in an initial state, a drive potential VDD is applied to the individual electrodes 133, and the actuator 130 (see FIG. 6), which is the portion of the diaphragm 131 and the piezoelectric layer 132 sandwiched between each individual electrode 133 and each pressure chamber 12P, is deformed into a convex shape protruding toward the pressure chamber 12P.

The ejection drive signal Sa0 maintains the individual electrode 133 at the drive potential VDD (i.e., the actuator 130 remains in a convexly deformed state protruding toward the pressure chamber 12P). In the ejection drive signal Sa1, when the individual electrode 133 reaches the ground potential, the actuator 130 flattens, increasing the volume of the pressure chamber 12P compared to the initial state. At this time, ink is drawn from the common flow path 121 into the individual flow path 122. Subsequently, at a particular timing, the drive potential VDD is applied again to the individual electrode 133, causing the actuator 130 to deform convexly toward the pressure chamber 12P. As a result, the volume of the pressure chamber 12P decreases, increasing the ink pressure and ejecting ink from the nozzle 123.

The actuator 130 is provided for each of the individual electrodes 133 (i.e., for each of the nozzles 123) and can be independently deformed according to the potential supplied to the respective individual electrodes 133.

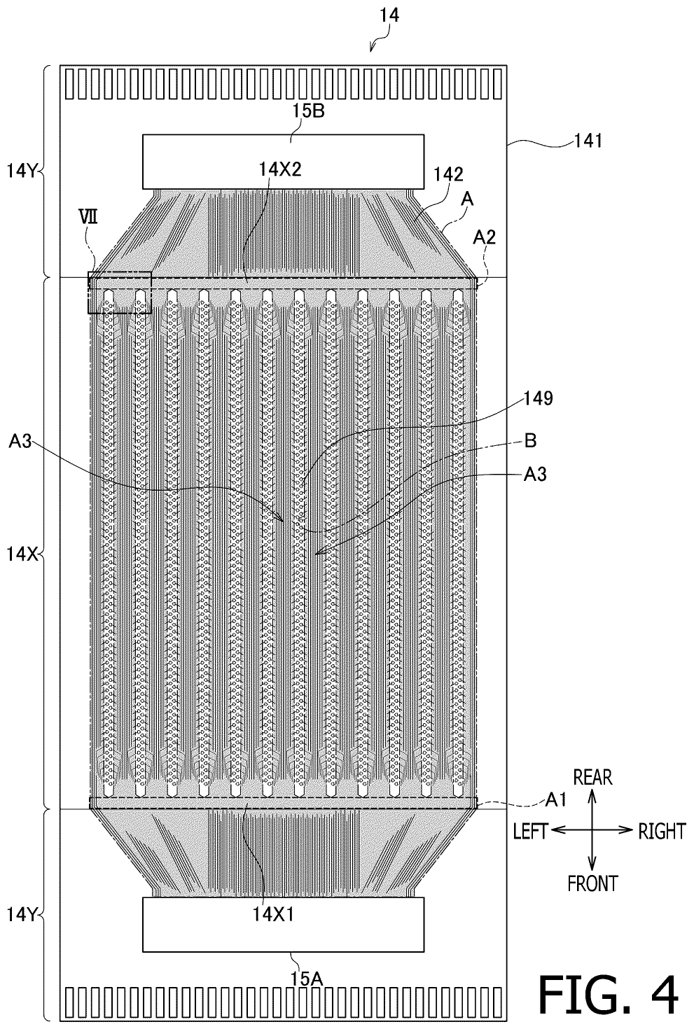

As shown in FIG. 3, the COF 14 includes a connection portion 14X arranged on the upper surface 13X of the actuator member 13 and two lead portions 14Y extending from a front end 14X1 and a rear end 14X2 of the connection portion 14X in the front-rear direction. The connection portion 14X extends parallel to the upper surface 13X along the front-rear direction and the left-right direction. A plurality of contacts 149 (see FIG. 4) are arranged on the lower surface of the connection portion 14X. The connection portion 14X corresponds to an “opposing portion” according to the present disclosure.

Each of the two lead portions 14Y includes a vertical section 14YV extending upward from the front end 14X1 or the rear end 14X2 of the connection portion 14X, and a horizontal section 14YH extending from the upper end of the vertical section 14YV toward the center of the head 10 in the front-rear direction. A driver IC 15A is arranged on the upper surface of the horizontal section 14YH of the front lead portion 14Y, and a driver IC 15B is arranged on the upper surface of the horizontal section 14YH of the rear lead portion 14Y.

As shown in FIG. 3, the actuator member 13 and the COF 14 are arranged within the frame 19. A space enclosed by the connection portion 14X of the COF 14 and the two lead portions 14Y accommodates a pressing member 18, a support member 16, and a circuit board 17. The pressing member 18, the support member 16, and the circuit board 17 are positioned above the connection portion 14X. The vertical sections 14YV of the lead portions 14Y are arranged along the side surface of the pressing member 18.

As shown in FIG. 3, the lower surface of the pressing member 18 is arranged with a gap from a region 13R on the upper surface 13X of the actuator member 13 where the plurality of individual electrodes 133 (see FIG. 5) are arranged, as well as from the connection portion 14X connected to the region 13R. A peripheral portion of the lower surface of the pressing member 18 is in contact with the connection portion 14X and presses the connection portion 14X downward toward the actuator member 13.

The support member 16 is supported from below by the pressing member 18 and supports three circuit boards 17 on its lower surface. The circuit boards 17 are arranged in recesses formed on the upper surface of the pressing member 18 and are electrically connected to the COF 14.

A sealing material 20 is arranged along an inner periphery of the frame 19. The sealing material 20 isolates the space between the connection portion 14X and the actuator member 13 from the external environment. With this configuration, ion migration between the individual electrodes 133, which could otherwise occur due to the ingress of moisture from the atmosphere, is prevented. The sealing material 20 may be made of a non-conductive material such as fluororesin.

As shown in FIG. 4, which is a development view, the COF 14 includes a rectangular substrate 141 that defines the outer shape of the COF 14. The substrate 141 extends across the connection portion 14X and the two lead portions 14Y. The substrate 141 is made of a flexible and insulating material such as polyimide.

A plurality of wirings 142 and a plurality of contacts 149 are arranged on the substrate 141. Each wiring 142 extends across the connection portion 14X and the two lead portions 14Y, extending from one of the driver ICs 15A or 15B arranged on the lead portions 14Y toward the corresponding contact 149 arranged on the connection portion 14X. A contact 149 is arranged at one end (tip) of each wiring 142, while the other end of each wiring 142 is connected to one of output terminal 15A1 of the driver IC 15A or output terminal 15B1 of the driver IC 15B (see FIG. 9).

In this embodiment, every two wirings 142 are electrically connected to one contact 139. Therefore, the two wirings 142 are connected to a common contact 149 that is connected to one contact 139. Alternatively, a contact may be provided at each end of the wirings 142, and two separate contacts 149 may be connected to one contact 139. The wirings 142 and the contacts 149 may be made of any conductive material.

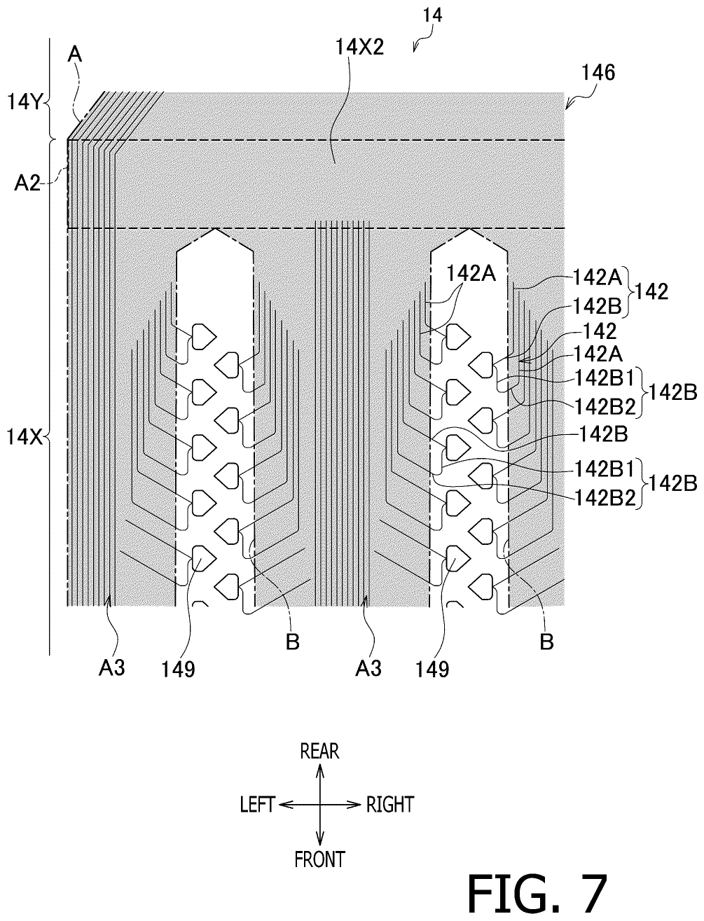

As shown in FIGS. 4 and 7, the COF 14 includes a wiring region A, where a plurality of wirings 142 are arranged on the substrate 141, and a contact region B, which is outside the wiring region A and where a plurality of contacts 149 are arranged. In the wiring region A, the plurality of wirings 142 are arranged side by side in the left-right direction.

The wiring region A is arranged across the connection portion 14X and the two lead portions 14Y. On the other hand, the contact region B is arranged on the connection portion 14X and is not arranged on the lead portions 14Y.

In the connection portion 14X, a total of 12 contact regions B are arranged at intervals in the left-right direction. Each contact region B extends in the front-rear direction. The plurality of contacts 149 are arranged in two staggered rows along the front-rear direction, except at both end portions of the contact regions B in the front-rear direction.

The wiring region A provided in the connection portion 14X includes an outer edge portion A1 along the front end 14X1 of the connection portion 14X, an outer edge portion A2 along the rear end 14X2 of the connection portion 14X, and a plurality of interposing portions A3 arranged in such a manner that the plurality of interposing portions A3 sandwich the contact regions B in the left-right direction.

The outer edge portion A1 extends in the left-right direction and is in contact with the front ends of the plurality of contact regions B. The outer edge portion A2 extends in the left-right direction and is in contact with the rear ends of the plurality of contact regions B. The interposing portions A3 extend in the front-rear direction, similar to the contact regions B.

Here, the plurality of wirings 142 will be described. As shown in FIG. 7, each wiring 142 includes a first portion 142A arranged in the wiring region A and a second portion 142B that connects the first portion 142A to the contact 149. The first portion 142A extends in the front-rear direction within the interposing portion A3 of the wiring region A in the connection portion 14X.

The first portion 142A of the wirings 142 connected to the contacts 149 belonging to the right-side row in the contact region B is arranged in the interposing portion A3 located to the right of the corresponding contact 149. Conversely, the first portion 142A of the wirings 142 connected to the contacts 149 belonging to the left-side row is arranged in the interposing portion A3 located to the left of the corresponding contact 149. As a result, the second portion 142B of the wirings 142 connected to the contacts 149 in the right-side row is linked to the first portion 142A arranged in the right-side interposing portion A3 of the two interposing portions A3, while the second portion 142B of the wirings 142 connected to the contacts 149 in the left-side row is linked to the first portion 142A arranged in the left-side interposing portion A3 of the two interposing portions A3.

As shown in FIG. 7, two second portions 142B (i.e., a front-side second portion and a rear-side second portion) are connected to each contact 149. The front-side second portion 142B includes a section 142B1 extending in the front-rear direction and a connecting section 142B2 that links the section 142B1 to the first portion 142A. In contrast, the rear-side second portion 142B includes only a section extending in an intersecting direction that crosses both the front-rear and left-right directions, serving as a connecting section that links the contact 149 to the first portion 142A in this embodiment. It should be noted that the rear-side second portion 142B may also include a section extending in the front-rear direction.

With this configuration, one of the two wirings 142 connected to each contact 149 in the contact region B includes the extending portion 142B1. The extending portion 142B1 is located, in the left-right direction, between the contact 149 and a boundary, which is the boundary between the contact region B and the interposing portion A3 where the first portion 142A is located.

A solder resist layer 146 made of a non-conductive material is arranged on the substrate 141 so as to cover the wirings 142. The solder resist layer 146 is arranged in regions other than the contact region B, specifically in the wiring region A, and is arranged over substantially the entire lower surface of the substrate 141.

As shown in FIG. 9, the controller 8 includes a CPU 81, a ROM 82, a RAM 83, and an ASIC 84. The ROM 82 stores programs and data for the CPU 81 and the ASIC 84 to perform various control operations. The RAM 83 temporarily stores data (such as image data) used by the CPU 81 and the ASIC 84 when executing programs. The controller 8 is communicably connected to an external device 85 (such as a personal computer) and executes a recording (printing) process and other operations based on data input from the external device 85 or an input unit of the printer 100 (e.g., switches or buttons provided on the outer surface of a housing of the printer 100). The ASIC 84 is electrically connected to the driver ICs 15A and 15B, the carriage motor 30M, and the conveyance motor 70M.

In the recording process, the ASIC 84, following commands from the CPU 81, drives the driver ICs 15A and 15B, the carriage motor 30M, and the conveyance motor 70M based on a recording command received from the external device 85 or other sources. The ASIC 84 alternately performs a conveyance operation, in which the conveyance mechanism 70 conveys the printing sheet 9 by a particular amount in the conveyance direction, and a scanning operation, in which ink is ejected from the nozzles 123 while moving the head 10 in the scanning direction. As a result, ink dots are formed on the printing sheet 9, and an image is recorded.

The ASIC 84 includes an output circuit 84A and a transfer circuit 84B. The output circuit 84A generates the waveform signal FIRE and the selection signal SIN and outputs these signals to the transfer circuit 84B for each ejection cycle. The waveform signal FIRE is a serial signal in which the two ejection drive signals Sa0 and Sa1 (see FIGS. 8A and 8B) are serialized.

The selection signal SIN is a serial signal that includes selection data for selecting one of the two ejection drive signals Sa0 and Sa1. It is generated for each actuator 130 and for each ejection cycle based on image data included in the recording command.

The transfer circuit 84B transfers the waveform signal FIRE and the selection signal SIN received from the output circuit 84A to the driver ICs 15A and 15B. The transfer circuit 84B includes an internal Low Voltage Differential Signaling (LVDS) driver corresponding to each signal and transfers each signal to the driver ICs 15A and 15B as a pulse-shaped differential signal.

In the recording process, the ASIC 84 controls the driver ICs 15A and 15B to generate ejection drive signals Sa0 and Sa1 for each pixel (dot) based on the waveform signal FIRE and the selection signal SIN. The driver ICs 15A and 15B then supply the ejection drive signals Sa0 and Sa1 to the individual electrodes 133 via the wirings 142 from their respective output terminals 15A1 and 15B1. More specifically, for each individual electrode 133, the driver ICs 15A and 15B respectively output the same drive signals (either ejection drive signal Sa0 or Sa1) at the same timing to the two wirings 142 that share a common contact 149 connected to the same contact 139. In other words, the driver ICs 15A and 15B output the same drive signals at the same timing to the two contacts 149 (i.e., a single shared contact 149) connected to the same contact 139. As a result, the same drive signal is supplied to each individual electrode 133 via two wirings 142 from the driver ICs 15A and 15B. In this manner, the ASIC 84 controls the ejection of ink with a selected ejection amount (zero or a desired amount) from each of the plurality of nozzles 123 toward the printing sheet 9 for each pixel.

As described above, in the head 10 of this embodiment, for each contact 139, two wirings 142 are connected at one end to a common contact 149, while the other ends of these wirings 142 are respectively connected to the output terminals 15A1 and 15B1 of the driver ICs 15A and 15B. This configuration allows a drive signal to be output to each individual electrode 133 from two of the multiple output terminals 15A1 and 15B1 of the driver ICs 15A and 15B. In other words, when driving the actuator member 13 at high speed, a drive signal can be output to a single individual electrode 133 via two wirings 142 (transmission paths). As a result, the quality of the drive signal supplied to the individual electrodes 133 from the driver ICs 15A and 15B can be maintained at a high level.

The driver ICs 15A and 15B respectively output the same drive signals at the same timing to the two contacts 149 (a single shared contact 149) connected to the same contact 139. As a result, the same drive signal is output to a single contact 139 (individual electrode 133) from two sources. If a drive signal were supplied to an individual electrode 133 via only one wiring 142, the transmission path would be limited to a single wiring 142. In such a case, if the wiring 142 experiences relatively high transmission loss, this loss could affect the drive signal, causing the drive potential to drop below a particular potential, thereby degrading the quality of the drive signal supplied to the individual electrode 133. However, in the present configuration, the same drive signal is supplied to a single individual electrode 133 via two wirings 142. This means that among the two wirings 142, the wiring 142 with lower transmission loss can supply a high-quality drive signal to the individual electrode 133, thereby maintaining the quality of the drive signal supplied to the individual electrode 133 at high level. Consequently, a desired voltage can be applied to a single individual electrode 133, and the current supply capability is also improved.

Among the two second portions 142B connected to the two contacts 149 (the same contact 149) that are linked to the same contact 139, one second portion 142B includes an extending portion 142B1. As a result, when forming the solder resist layer 146 of the COF 14, even if the material constituting the solder resist layer 146 (solder resist) attempts to flow from the wiring region A into the contact region B, the extending portion 142B1 of the second portion 142B acts as a barrier, suppressing the progression of the inflow. This prevents the plurality of contacts 149 from being covered by the solder resist layer 146.

While one embodiment of aspects of the present disclosure has been described above and illustrated in the figures, various alternatives, modifications, variations, improvements, and substantial equivalents, whether known or presently unforeseen, may become apparent to those having at least ordinary skill in the art. Accordingly, the example embodiment set forth above is intended to be illustrative and not limiting. Various changes may be made without departing from the spirit and scope of the disclosure. Therefore, the disclosure is intended to encompass all known or later-developed alternatives, modifications, variations, improvements, and substantial equivalents. Some specific examples of potential alternatives, modifications, or variations are provided in the following embodiments.

### Second Embodiment

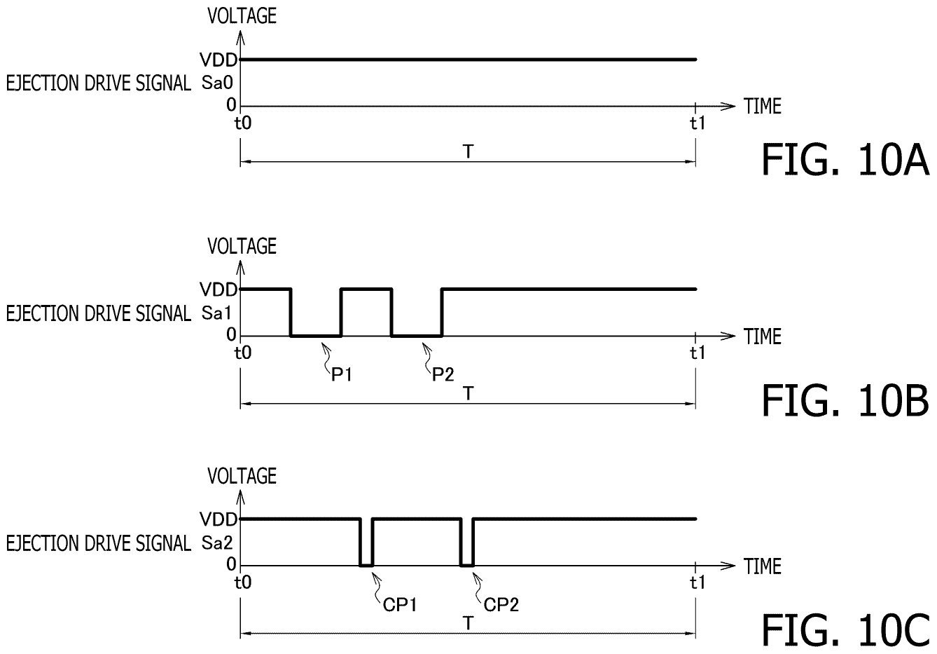

Next, referring to FIGS. 10A, 10B and 10C, the head 10 according to the second embodiment of the present disclosure will be described. In this embodiment, the drive signals output from the respective output terminals 15A1 and 15B1 of the driver ICs 15A and 15B include an additional ejection drive signal Sa2, in addition to the ejection drive signals Sa0 and Sa1 of the first embodiment. The ejection drive signal Sa2 includes two rectangular cancel pulses CP1 and CP2 within the unit time T. These cancel pulses CP1 and CP2 have different application timings from the pulses P1 and P2 of the ejection drive signal Sa1 within the unit time T. More specifically, the cancel pulse CP1 is applied after the pulse P1 of the ejection drive signal Sa1 and before the pulse P2, while the cancel pulse CP2 is applied after the pulse P2 of the ejection drive signal Sa1. The cancel pulses CP1 and CP2 have the same pulse width, which is smaller than that of pulses P1 and P2. By supplying the ejection drive signals Sa1 and Sa2 to the same individual electrode 133 at the same timing, these cancel pulses CP1 and CP2 enable the suppression of satellite droplets and mist generated by ink ejection from the nozzle 123 due to the ejection drive signal Sa1.

The pulses P1 and P2 are examples of the “first pulse” according to the present disclosure, while the cancel pulses CP1 and CP2 are examples of a “second pulse” according to the present disclosure. The ejection drive signal Sa1 is an example of the “first drive signal” according to the present disclosure, and the ejection drive signal Sa2 is an example of the “second drive signal” according to the present disclosure.

In this embodiment, the ASIC 84 controls the driver ICs 15A and 15B during the recording process to generate the ejection drive signals Sa0, Sa1 and Sa2 for each pixel (dot) based on the waveform signal FIRE and the selection signal SIN. The driver ICs 15A and 15B then supply the ejection drive signals Sa0, Sa1, and Sa2 to the individual electrodes 133 via the wirings 142 from their respective output terminals 15A1 and 15B1.

More specifically, the driver ICs 15A and 15B respectively output the same ejection drive signals Sa0 at the same timing to the two wirings 142 that share a common contact 149 connected to the same contact 139 for the individual electrode 133 to which the ejection drive signal Sa0 is supplied.

On the other hand, for an individual electrode 133 to which the ejection drive signal Sa1 is output, the driver ICs 15A and 15B output the ejection drive signal Sa1 to one of the two wirings 142 having a common contact 149 connected to the same contact 139, while outputting the ejection drive signal Sa2 to the other wiring 142 at the same timing. In other words, the driver ICs 15A and 15B respectively output the ejection drive signal Sa1 and the ejection drive signal Sa2 at the same timing to the two contacts 149 connected to the same contact 139. As a result, a synthesized drive signal, which is a combination of the ejection drive signals Sa1 and Sa2, is output to a single individual electrode 133. If, in an attempt to achieve high-speed driving of the actuator 130, the synthesized drive signal were treated as a single drive signal and output to a single individual electrode 133 via a single transmission path (wiring 142), the potential switching of pulses P1 and P2 and cancel pulses CP1 and CP2 might not be able to keep up, potentially preventing the desired ink ejection. However, in the present configuration, where the ejection drive signals Sa1 and Sa2 are output to the contact 149 via separate wirings 142 and then synthesized at the individual electrode 133, additional timing margin is created for the potential switching of pulses P1 and P2 in the ejection drive signal Sa1 and cancel pulses CP1 and CP2 in the ejection drive signal Sa2. This ensures reliable potential switching of pulses P1, P2, CP1, and CP2, thereby maintaining the quality of the drive signal. In other words, this configuration enables high-speed driving of the actuator 130.

### Third Embodiment

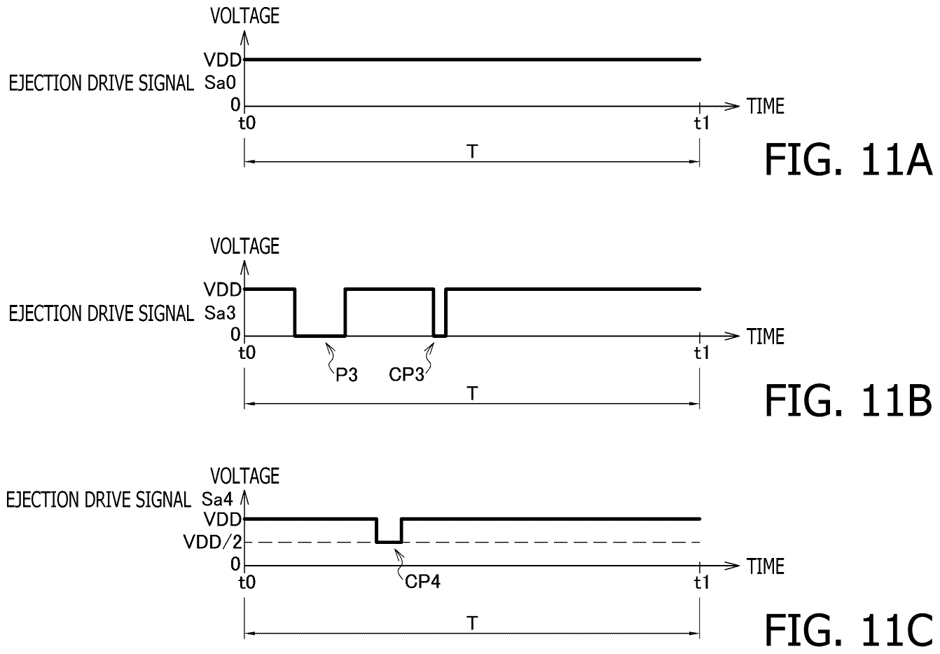

Next, referring to FIGS. 11A, 11B and 11C, the head 10 according to the third embodiment of the present disclosure will be described. In this embodiment, the drive signals output from the respective output terminals 15A1 and 15B1 of the driver ICs 15A and 15B include, in addition to the ejection drive signal Sa0 of the first embodiment, ejection drive signals Sa3 and Sa4. The ejection drive signal Sa3 includes, within the unit time T, a pulse P3 and a cancel pulse CP3 that is applied after the pulse P3. Both the pulse P3 and the cancel pulse CP3 are rectangular pulses, and the pulse width of the cancel pulse CP3 is smaller than that of the pulse P3.

The ejection drive signal Sa4 includes a single cancel pulse CP4 within the unit time T. The cancel pulse CP4 is a rectangular pulse and has an application timing different from the application timings of both the pulse P3 and the cancel pulse CP3 in the ejection drive signal Sa3 within the unit time T. More specifically, the cancel pulse CP4 is applied after the pulse P3 in the ejection drive signal Sa3 and before the cancel pulse CP3. Additionally, the cancel pulse CP4 can switch to a voltage value different from that of pulse P3, transitioning the potential from the drive potential VDD to half of the drive potential VDD (which is higher than the ground potential). Furthermore, the pulse width of the cancel pulse CP4 is larger than that of the cancel pulse CP3 but smaller than that of the pulse P3. By supplying the ejection drive signals Sa3 and Sa4 to the same individual electrode 133 at the same timing, the cancel pulse CP4 effectively suppresses satellite droplets and mist generated by ink ejection from the nozzle 123 due to the ejection drive signal Sa3.

The pulse P3 or the cancel pulse CP3 is an example of the “first pulse” according to the present disclosure, while the cancel pulse CP4 is an example of the “second pulse” according to the present disclosure. The ejection drive signal Sa3 is an example of the “first drive signal” according to the present disclosure, and the ejection drive signal Sa4 is an example of a “second drive signal” according to the present disclosure.

In this embodiment, during the recording process, the ASIC 84 controls the driver ICs 15A and 15B to generate the ejection drive signals Sa0, Sa3, and Sa4 for each pixel (dot) based on the waveform signal FIRE and the selection signal SIN. The driver ICs 15A and 15B then supply the ejection drive signals Sa0, Sa3, and Sa4 to the individual electrodes 133 via the wirings 142 from their respective output terminals 15A1 and 15B1.

More specifically, the driver ICs 15A and 15B output the same ejection drive signal Sa0 at the same timing to the two wirings 142 that share a common contact 149 connected to the same contact 139 for the individual electrode 133 to which the ejection drive signal Sa0 is supplied.

On the other hand, the driver ICs 15A and 15B output the ejection drive signal Sa3 to one of the two wirings 142 having a common contact 149 connected to the same contact 139, while outputting the ejection drive signal Sa4 to the other wiring 142 at the same timing. In other words, the driver ICs 15A and 15B output both the ejection drive signal Sa3 and the ejection drive signal Sa4 at the same timing to the two contacts 149 connected to the same contact 139. As a result, a synthesized drive signal, which is a combination of the ejection drive signals Sa3 and Sa4, is output to a single individual electrode 133, achieving the same effect as in the second embodiment. Additionally, since the synthesized drive signal combines the ejection drive signals Sa3 and Sa4, a complex waveform with different voltage values is output to the individual electrode 133.

### Fourth Embodiment

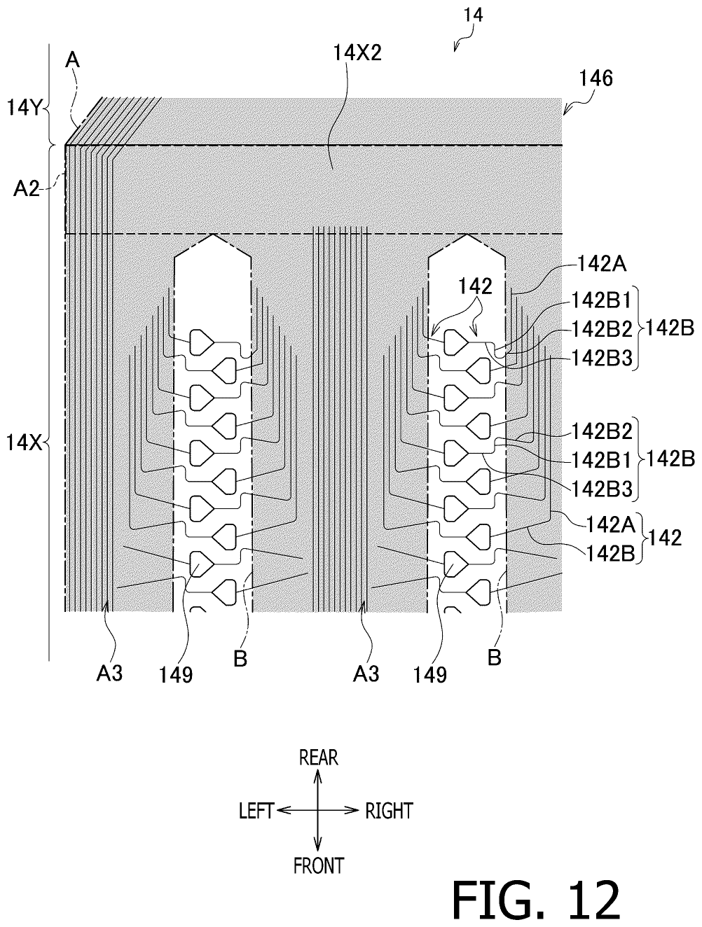

Next, referring to FIG. 12, the head 10 according to the fourth embodiment of the present disclosure will be described. In this embodiment, among the two wirings 142 that share a common contact 149 connected to the same contact 139, the first portion 142A of one wiring 142 (e.g., the left-side or right-side wiring) is arranged in one of the two interposing portions A3 sandwiching the contact region B (e.g., the left-side or right-side interposing portion A3). Meanwhile, the first portion 142A of the other wiring 142 (e.g., the right-side or left-side wiring) is arranged in the other interposing portion A3 (e.g., the right-side or left-side interposing portion A3). Each wiring 142 also includes a first portion 142A and a second portion 142B that connects the first portion 142A to the contact 149.

Among the two wirings 142 connected to the common contact 149, the second portion 142B of one wiring 142 extends in an intersecting direction that crosses both the front-rear and left-right directions in this embodiment and is configured as a connecting section that links the contact 149 to the first portion 142A. However, it may also include a section extending in the front-rear direction. The second portion 142B of the other wiring 142 includes a section 142B1 extending in the front-rear direction, a connecting section 142B2 that links the extending section 142B1 to the first portion 142A, and another section 142B3 extending in the left-right direction to connect the extending section 142B1 to the contact 149.

With this configuration, among the two wirings 142 connected to each contact 149 in the contact region B, the other wiring 142 includes an extending portion 142B1. This extending portion 142B1 is located, in the left-right direction, between the interposing portion A3 where the first portion 142A is arranged, the boundary of the contact region B, and the contact 149. Furthermore, multiple extending portions 142B1 are arranged in a staggered two-row pattern along the front-rear direction, except at both ends of the contact region B in the front-rear direction.

Among the two second portions 142B connected to the two contacts 149 (a single shared contact 149) that are linked to the same contact 139, one second portion 142B includes an extending portion 142B1. As a result, when forming the solder resist layer 146 of the COF 14, even if the material constituting the solder resist layer 146 (solder resist) attempts to flow from the wiring region A into the contact region B, the extending portion 142B1 of the second portion 142B acts as a barrier, suppressing the progression of the inflow. This prevents multiple contacts 149 from being covered by the solder resist layer 146.

While preferred embodiments of the present disclosure have been described above, the present disclosure is not limited to these embodiments, and various modifications can be made within the scope defined by the claims.

In the above-described embodiments, two contacts 149 (a single shared contact 149) are connected to one contact 139. However, three or more contacts 149 of the wirings 142 may be connected to a single contact 139. In this case as well, similar effects to those of the aforementioned embodiments can be achieved.

The pulses and cancel pulses in the ejection drive signals Sa1 to Sa4 of the first to third embodiments may include an arbitrary number of pulses, and the number of pulses is not particularly limited. Additionally, the shape of the pulses and cancel pulses may be of any form.

The electrodes constituting the actuator 130 described above have a two-layer structure, including the individual electrodes 133 and the vibration plate 131 (common electrode). However, a three-layer structure may also be employed. For example, a three-layer structure may include a drive electrode to which a high potential and a low potential are selectively applied, a high-potential electrode maintained at a high potential, and a low-potential electrode maintained at a low potential.

The type of liquid ejection head in the present disclosure is not limited to a serial type and may also be a line type.

The object onto which liquid is ejected from the nozzle 123 is not limited to paper and may be, for example, fabric, a substrate, or a plastic member.

The liquid ejected from the nozzle 123 is not limited to ink and may be any liquid, such as a treatment liquid that aggregates or precipitates components in the ink.

The present disclosure is not limited to printers and is also applicable to fax machines, copiers, multifunction devices, and the like. Additionally, the present disclosure is applicable to liquid ejection heads used for purposes other than image recording, such as liquid ejection heads that eject conductive liquid onto a substrate to form a conductive pattern.

What is claimed is:

1. A liquid ejection head comprising:
a flow path member including a plurality of pressure chambers;
an actuator member arranged on an upper surface of the flow path member, the actuator member including a plurality of individual electrodes and a plurality of first contacts, the plurality of individual electrodes overlapping the plurality of pressure chambers in an up-down direction, respectively, the plurality of first contacts being arranged on an upper surface of the actuator member and connected to the plurality of individual electrodes, respectively;
a wiring member arranged on the upper surface of the actuator member, the wiring member including a plurality of wirings, each of the plurality of wirings having a second contact at one end, the second contact being connected to the plurality of first contacts; and
a driving member including a plurality of output terminals configured to output a drive signal, each of the plurality of output terminals being connected to another end of the plurality of wirings,
wherein at least two of a plurality of the second contacts are connected to one of the plurality of first contacts.

2. The liquid ejection head according to claim 1,
wherein the drive signal include at least one pulse within one ejection period corresponding to one dot, and
wherein the driving member configured to output the drive signal at the same timing to a plurality of the second contacts connected to the same one of the plurality of first contacts.

3. The liquid ejection head according to claim 1,
wherein the drive signal includes a first drive signal and a second drive signal, the first drive signal being a signal including at least one first pulse within one ejection period corresponding to one dot, the second drive signal being a signal including at least one second pulse within the one ejection period, an application timing of the second pulse being different from an application timing of the first pulse,
wherein the driving member configured to output the first drive signal to one of the plurality of the second contacts connected to the same one of the plurality of first contacts, and output the second drive signal to another one of the plurality of the second contacts at the same timing of output of the first drive signal.

4. The liquid ejection head according to claim 1,
wherein the drive signal includes a first drive signal and a second drive signal, the first drive signal being a signal including at least one first pulse within one ejection period corresponding to one dot, the second drive signal being a signal including at least one second pulse within the one ejection period, an application timing of the second pulse being different from an application timing of the first pulse, a voltage value of the second pulse being different from a voltage value of the first pulse,
wherein the driving member configured to output the first drive signal to one of the plurality of the second contacts connected to the same one of the plurality of first contacts, and output the second drive signal to another one of the plurality of the second contacts at the same timing of output of the first drive signal.

5. The liquid ejection head according to claim 1,
wherein the wiring member having an opposing portion facing the actuator member in the up-down direction, the opposing portion having a wiring region where the plurality of wirings are arranged in a second direction crossing both the up-down direction and a first direction orthogonal to the up-down direction and a contact region different from the wiring region, the contact region being a region where the plurality of the second contacts are arranged,
wherein the wiring member includes a substrate where the plurality of the second contacts and the plurality of wirings are arranged and a solder resist layer arranged on the substrate in such a manner that the solder resist layer covers the plurality of wirings arranged on the substrate,
wherein each of the plurality of wirings includes a first portion arranged on the wiring region and a second portion configured to connect the first portion and the second contacts,
wherein the wiring region includes two interposing portions arranged in such a manner that the two interposing portions sandwiches the contact region in the second direction, and
wherein a plurality of the second portions respectively connected to the plurality of second contacts linked to the same first contact links the first part arranged at one of the two interposing portions to the plurality of second contacts, at least one of the plurality of second portions including a part extending in the first direction.

6. The liquid ejection head according to claim 1,
wherein the wiring member having an opposing portion facing the actuator member in the up-down direction, the opposing portion having a wiring region where the plurality of wirings are arranged in a second direction crossing both the up-down direction and a first direction orthogonal to the up-down direction and a contact region different from the wiring region, the contact region being a region where the plurality of the second contacts are arranged,
wherein the wiring member includes a substrate where the plurality of the second contacts and the plurality of wirings are arranged and a solder resist layer arranged on the substrate in such a manner that the solder resist layer covers the plurality of wirings arranged on the substrate,
wherein each of the plurality of wirings includes a first portion arranged on the wiring region and a second portion configured to connect the first portion and the second contacts,
wherein the wiring region includes two interposing portions arranged in such a manner that the two interposing portions sandwiches the contact region in the second direction, and
wherein one of a plurality of the second portions respectively connected to the plurality of second contacts linked to the same first contact links the first part arranged at one of the two interposing portions to the plurality of second contacts, another of the plurality of the second portions links the first part arranged at other of the two interposing portions to the plurality of second contacts, at least one of the plurality of second portions including a part extending in the first direction.
